(19) United States
(12) Patent Application Publication
(10) Pub. No.: US 2011/0128591 A1
(43) Pub. Date: Jun. 2, 2011

(54) SCAN APPARATUS AND CARRIER SHEET HAVING BACKGROUND PATTERN FOR BOUNDARY DETECTION

(76) Inventor: Chun-Chieh LIAO, Hsinchu City (TW)

(21) Appl. No.: 12/950,328

(22) Filed: Nov. 19, 2010

(30) Foreign Application Priority Data
Dec. 1, 2009 (TW) 098140924

(51) Int. Cl. H04N 1/04

(52) U.S. Cl. 358/474

(57) ABSTRACT

A scan apparatus having a background pattern for boundary detection includes a scan region, a scan assembly and a background member. The background member is disposed within the scan region and has the background pattern, which includes two sets of lines intersecting each other. The scan assembly scans an original and the background pattern of the background member within the scan region, and generates a corresponding image signal.

This application claims priority of No. 098140924 filed in Taiwan R.O.C. on Dec. 1, 2009 under 35 USC 119, the entire content of which is hereby incorporated by reference.

### BACKGROUND OF THE INVENTION

1. Field of the Invention

The present invention relates to a scan apparatus and a carrier sheet having a background pattern for boundary detection.

2. Related Art

During the operation of a conventional scanner, it usually involves the additional step of inputting the size of the original, or the step of previewing the scanned image and specifying the portion of the image they want by enclosing that portion of the preview image in a box, in order to define the effective edges of the original. To overcome the inconvenience brought by the conventional scanner, a black or white background member was adopted to assist in detecting the boundaries of the original by the method in which the scanner compares the colors of the background and the original image to determine the edges of the original. However, when the black background is utilized, the boundary of the original cannot be correctly determined if the color of the edge image is black or near black. When the white background is utilized, the boundary of the original also cannot be correctly determined if the color of the edge image is white. Consequently, the final image obtained, even after being processed, cannot correctly represent the image of the original.

### SUMMARY OF THE INVENTION

Accordingly, the present invention has been proposed to solve the problems of the prior art, and it is an object of the present invention to provide a scan apparatus and a carrier sheet having a background pattern for boundary detection, such that an image processing module can determine the boundary and perform the auto-cropping procedure.

To achieve the above-identified object, the present invention provides a scan apparatus including a scan assembly, a scan region and a background member. The background member is disposed within the scan region and has a background pattern, which includes two sets of lines intersecting each other. The scan assembly scans an original and the background pattern of the background member within the scan region, and generates a corresponding image signal.

The present invention further provides a carrier sheet including an original supporting sheet and a transparent sheet. The original supporting sheet has a background pattern, which includes two sets of lines intersecting each other. The transparent sheet, having one end attached to the original supporting sheet, is used for holding an original with the original supporting sheet. Through the transparent sheet, a scan assembly for scanning the original obtains an image representing the original and the background pattern.

With the aid of the background pattern formed by two intersecting sets of lines, it is possible to effectively detect the four edges of the original.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIGS. 1 and 2 are schematic illustrations showing a scan apparatus according to a first embodiment of the present invention.

FIG. 3 is a schematic illustration showing a scan apparatus according to a second embodiment of the present invention.

FIG. 4 is a schematic illustration showing a carrier sheet being used according to an embodiment of the present invention.

FIG. 5 is a pictorial view showing the carrier sheet of FIG. 4.

FIGS. 6 to 10 show several examples of the background members.

### DETAILED DESCRIPTION OF THE INVENTION

The present invention will be apparent from the following detailed description, which proceeds with reference to the accompanying drawings.

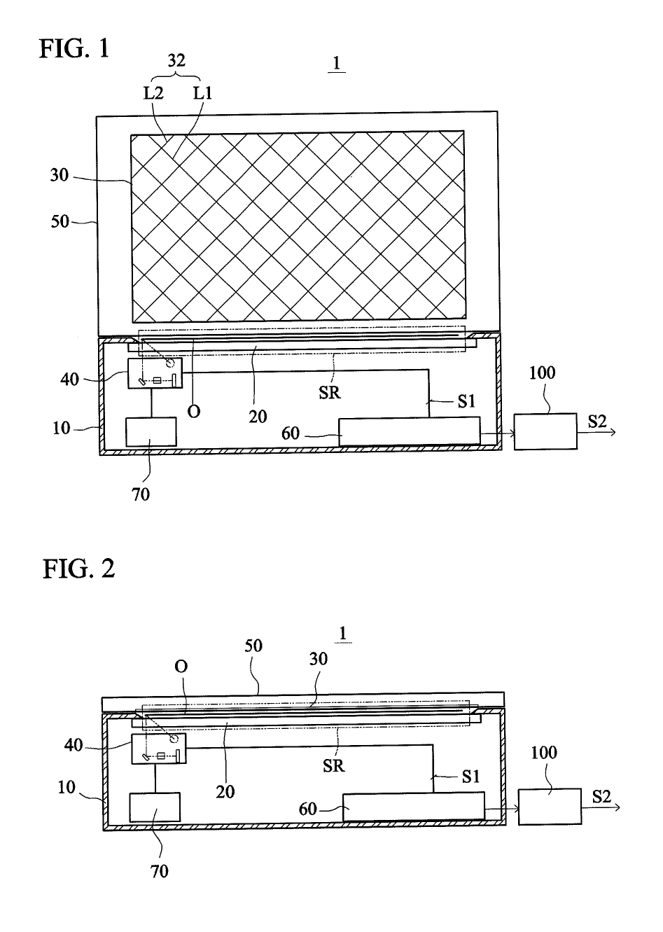

FIGS. 1 and 2 are schematic illustrations showing a scan apparatus 1 according to a first embodiment of the present invention. As shown in FIGS. 1 and 2, the scan apparatus 1 of this embodiment is a flatbed scanner, which includes an original supporting platen 20, a scan region SR, a background member 30 and a scan assembly 40. In addition, the scan apparatus 1 may further include a housing 10, an upper cover 50, a motherboard 60 and a driving mechanism 70. The motherboard 60 controls the scan assembly 40 and the driving mechanism 70, and performs image processing, such as analog-to-digital conversion, gain amplification and etc. The scan region SR represents the region within which the scan assembly 40 scans an original O. The driving mechanism 70 drives the scan assembly 40 to move back and forth.

The original supporting platen 20, disposed within the housing 10, supports the original O. In this embodiment, the original supporting platen 20 includes a transparent platen. The original O may be an ordinary sheet, a document, a photo or the like.

The background member 30 may be partially or entirely disposed within the scan region SR, or within the scan region SR and on an opposite side of the original supporting platen 20, and serves as a scan background for the original O. The background member 30 has a background pattern 32, which includes two sets of lines intersecting each other. The two sets of lines intersecting each other include straight lines with different slopes, or curved lines with different curvatures. Thus, the two sets of lines include straight lines, curved lines or straight lines and curved lines. In each set, the lines may be arranged in parallel. In addition, the two sets of lines may also include multiple colors.

In this embodiment, the two sets of lines include a first set of lines and a second set of lines. The first set of lines includes a plurality of first lines L1. The second set of lines includes a plurality of second lines L2. The first lines L1 may be equally or unequally spaced. The second lines L2 may be equally or unequally spaced.

The scan assembly 40, movably disposed within the housing 10, scans the original O and the background pattern 32 of the background member 30 within the scan region SR, and generates a corresponding image signal S1.

In FIGS. 1 and 2, the upper cover 50 is rotatably connected to the housing 10, and the background member 30 is supported on the upper cover 50. FIG. 1 shows the state that the upper cover 50 is opened with respect to the housing 10, and FIG. 2 shows the state that the upper cover 50 is closed upon the housing 10. It is to be noted that the user may alternatively use an individual, portable background member 30 to cover up the original O without using the upper cover 50.

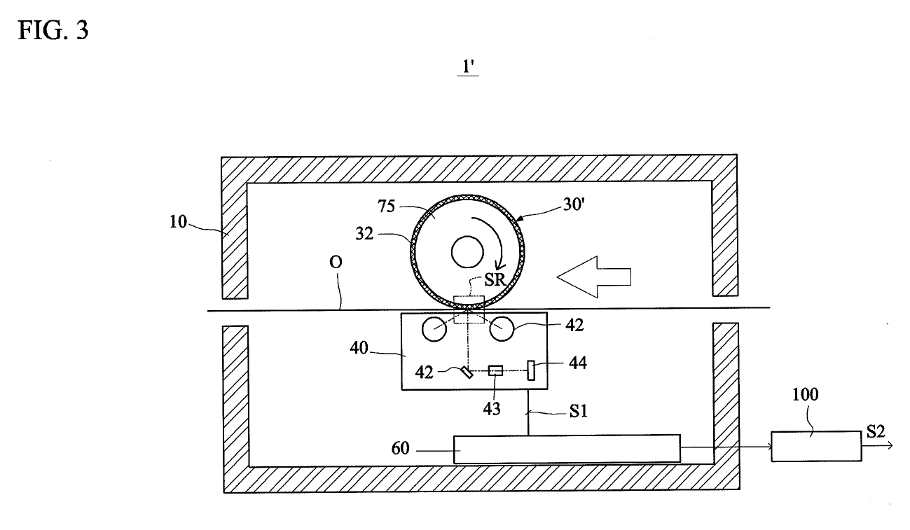

FIG. 3 is a schematic illustration showing a scan apparatus 1′ according to a second embodiment of the present invention. As shown in FIG. 3, the scan apparatus 1′ is a sheet-fed scanner including a transporting roller 75 rotating in a clockwise direction to transport the original O relatively to the scan assembly 40 in the direction indicated by the arrow. The background member 30′ is disposed on the outer circumferential surface of the transporting roller 75. As the stationary scan assembly 40 in FIG. 3 scans the original O, it senses the background pattern 32 on rotating background member 30′ in a similar manner as the moving scan assembly 40 in FIGS. 1 and 2 senses the background pattern 32 on the stationary background member 30. Similar to the scan assembly shown in FIGS. 1 and 2, the scan assembly 40 of FIG. 3 includes a light source 41, a reflecting mirror 42, a lens 43 and an image sensor 44. The light source 41 emits light beams to the original O, which reflects a portion of the light beams to the image sensor 44 through the reflecting mirror 42 and the lens 43. It is to be noted that the reflecting mirror 42 may be omitted, or additional reflecting mirrors 42 may be added, dependent on the type of the image sensor 44. The image sensor 44 may include a charge-coupled device (CCD) image sensor or a contact-type image sensor.

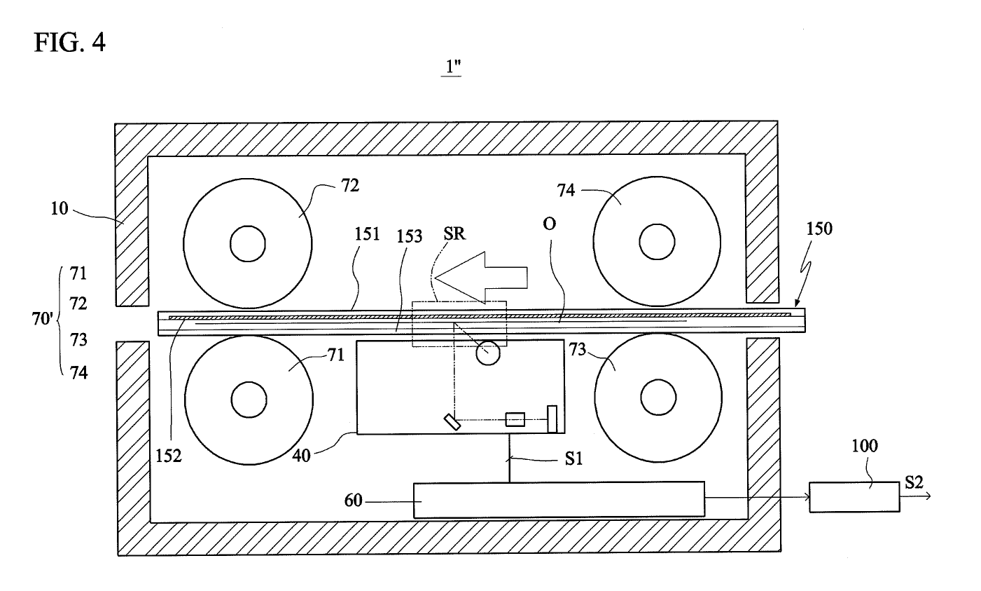

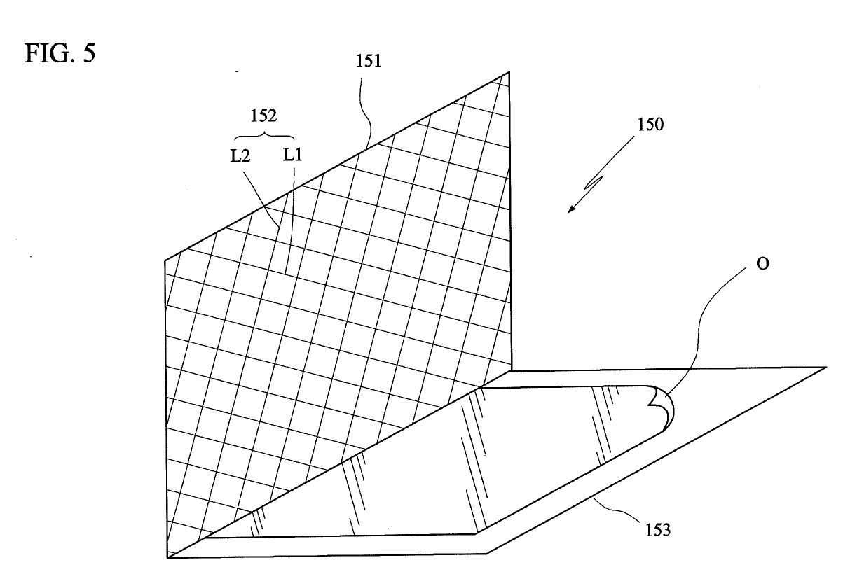

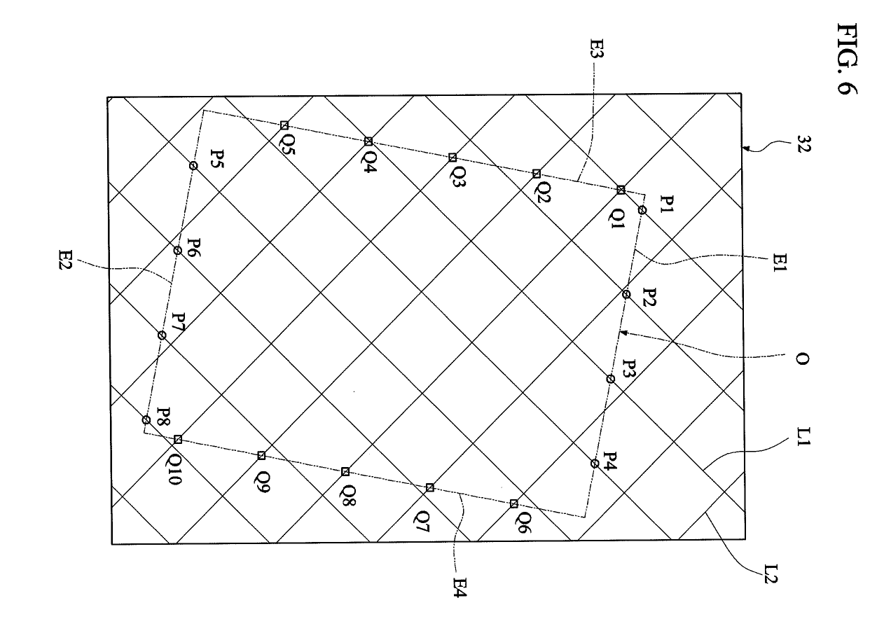

FIG. 4 is a schematic illustration showing a carrier sheet 150 being used according to an embodiment of the present invention. FIG. 5 is a pictorial view showing the carrier sheet 150 of FIG. 4. As shown in FIGS. 4 and 5, a scan apparatus 1″ of this embodiment is a sheet-fed scan apparatus, and the original O held by the carrier sheet 150 is fed into and scanned by the scan apparatus 1″. The scan apparatus 1″ of this embodiment includes a housing 10, a scan assembly 40, a motherboard 60 and a driving mechanism 70′. The driving mechanism 70′ includes a plurality of rollers 71, 72, 73 and 74 for transporting the original O and the carrier sheet 150 in a direction indicated by the arrow. The carrier sheet 150 includes an original supporting sheet 151 and a transparent sheet 153. The original supporting sheet 151 has a background pattern 152, which includes two sets of lines intersecting each other. One end of the transparent sheet 153 is connected to the original supporting sheet 151, so that the transparent sheet 153 holds the original O with the original supporting sheet 151. Through the transparent sheet 153, the scan assembly 40 scans the original O and obtains an image representing the original O and the background pattern 152. The user can firstly place the original O between the transparent sheet 153 and the original supporting sheet 151, and then place the carrier sheet 150, together with the original O therein, into the scan apparatus 1″, and finally activate the scan apparatus 1″ to perform the scan operation. In another embodiment, the scan apparatus may be a flatbed scanner, and the user can place the carrier sheet 150, carrying the original O, onto the scan platen, so that the original O can be scanned.

After the image signal S1 is obtained, the boundaries can be detected by way of image processing. As shown in FIGS. 1 to 4, the scan apparatus 1/1′/1″ is coupled to an image processing module 100, which means that the image processing module 100 may be externally coupled to the scan apparatus 1/1′/1″, for example, as an external computer, or built in the scan apparatus 1/1′/1″, as an internal processing circuit.

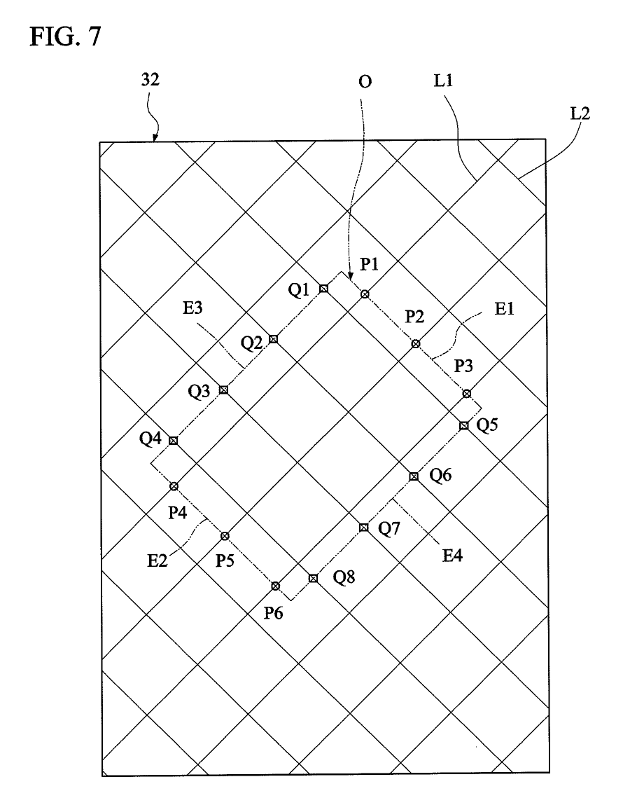

Several examples will be illustrated to describe how the lines can be adopted to facilitate the boundary detection. FIGS. 6 to 10 show several examples of the background members. As shown in FIGS. 1 to 4 and 6, the image processing module 100 recognizes the image representing the background pattern 32 in the image signal S1, and determines a plurality of edge positions P1 to P8 and Q1 to Q10 of a plurality of edges E1 to E4 of the original O. The edge positions P1 to P4 are the intersections of the edge E1 and the lines L1. The edge positions P5 to P8 are the intersections of the edge E2 and the lines L1. The edge positions Q1 to Q5 are the intersections of the edge E3 and the lines L2. The edge positions Q6 to Q10 are the intersections of the edge E4 and the lines L2.

Therefore, the edge E1 can be determined according to the edge positions P1 to P4, the edge E2 can be determined according to the edge positions P5 to P8, the edge E3 can be determined according to the edge positions Q1 to Q5, and the edge E4 can be determined according to the edge positions Q6 to Q10. Furthermore, when these edge positions are determined, the image processing module 100 can generate an original image signal S2 representing the image of the original O accordingly.

The above-mentioned descriptions may be summarized as follows. The edges E1 to E4 of the original 0 include two parallel first edges E1 and E2 and two parallel second edges E3 and E4. The image processing module 100 recognizes the images representing the first set of lines in the image signal S1 and determines the edge positions P1 to P8 of the first edges E1 to E2. The image processing module 100 recognizes the image corresponding to the second set of lines in the image signal S1 and determines the edge positions Q1 to Q10 of the second edges E3 and E4.

As shown in FIG. 7, when the edges E1 and E2 are parallel to the lines L2 and the edges E3 and E4 are parallel to the lines L1, the edges E1 to E4 may be similarly determined according to the intersections (edge positions P1 to P6) of the edges E1 and E2 and the lines L1, and the intersections (edge positions Q1 to Q8) of the edges E3 and E4 and the lines L2.

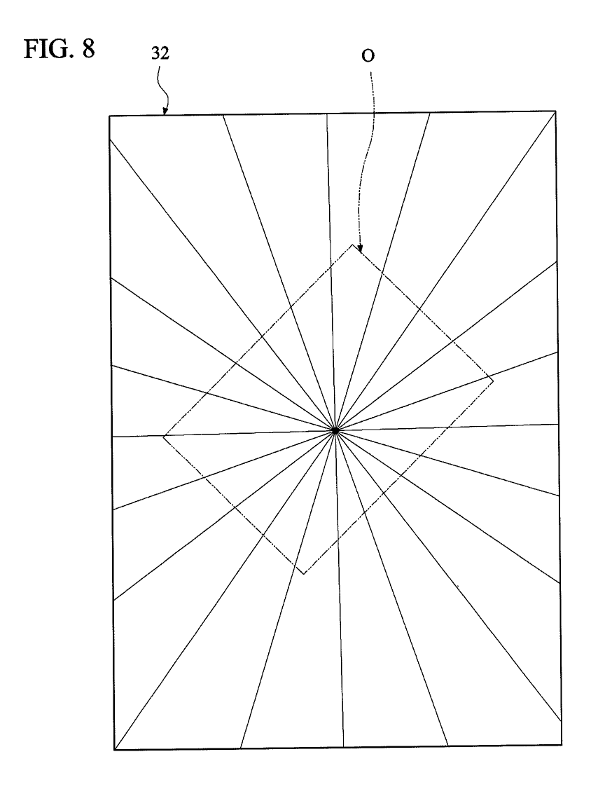

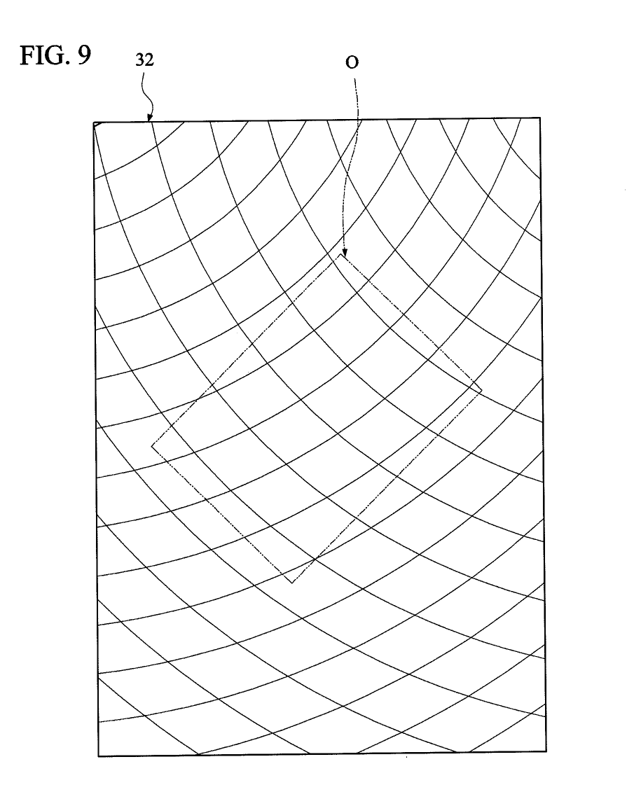

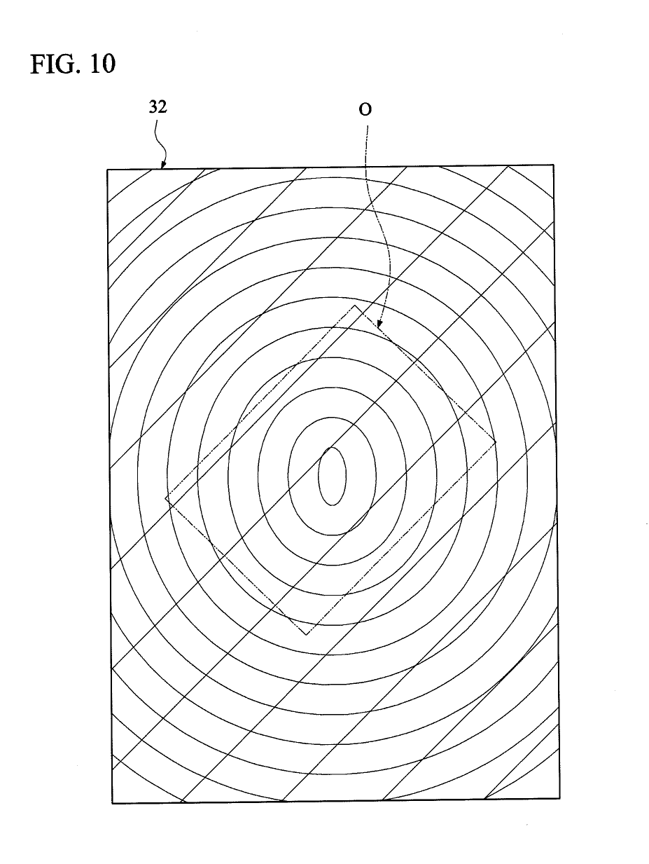

Similarly, the radial lines in FIG. 8, the two sets of curved lines in FIG. 9 and the one set of straight lines and the one set of curved lines in FIG. 10 may also be adopted to assist in detecting the edges or boundaries.

With the embodiments of the present invention, even when the original is placed askew, the edge detection of the original could be carried out successfully. Thus, the scan apparatus and the carrier sheet of the present invention facilitate the detection of the physical characteristics of the original, such as presence, width and skew of a document being scanned, and the image processing of the scanned image, such as de-skewing and auto-cropping, while overcoming the drawbacks of the automatic edge detection existing in the prior art.

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

What is claimed is:

1. A scan apparatus, comprising:
a scan assembly;
a scan region; and
a background member, disposed within the scan region and having a background pattern, which comprises two sets of lines intersecting each other,
wherein the scan assembly scans an original and the background pattern of the background member within the scan region, and generates a corresponding image signal.

2. The scan apparatus according to claim 1, further comprising a housing and an upper cover rotatably connected to the housing, wherein the background member is supported on the upper cover.

3. The scan apparatus according to claim 1, further comprising a transporting roller for transporting the original relatively to the scan assembly, wherein the background member is disposed on the transporting roller.

4. The scan apparatus according to claim 1, wherein the two sets of lines comprise:
a first set of lines comprising a plurality of first lines; and
a second set of lines comprising a plurality of second lines.

5. The scan apparatus according to claim 4, wherein the first lines are equally spaced, and the second lines are equally spaced.

6. The scan apparatus according to claim 4, wherein the first lines are unequally spaced, and the second lines are unequally spaced.

7. The scan apparatus according to claim 1, wherein the two sets of lines comprise straight lines.

8. The scan apparatus according to claim 1, wherein the two sets of lines comprise curved lines.

9. The scan apparatus according to claim 1, wherein the two sets of lines comprise multiple colors.

10. The scan apparatus according to claim 1 being coupled to an image processing module, wherein the image processing module recognizes an image representing the background pattern in the image signal and determines a plurality of edge positions of a plurality of edges of the original.

11. The scan apparatus according to claim 10, wherein the image processing module further generates an original image signal representing the original according to the edge positions.

12. The scan apparatus according to claim 10, wherein the two sets of lines comprise:
a first set of lines comprising a plurality of first lines; and
a second set of lines comprising a plurality of second lines.

13. The scan apparatus according to claim 12, wherein the edges of the original comprise two parallel first edges and two parallel second edges, the image processing module recognizes an image representing the first set of lines in the image signal and determines the edge positions of the first edges, and the image processing module recognizes an image representing the second set of lines in the image signal and determines the edge positions of the second edges.

14. A carrier sheet, comprising:
an original supporting sheet having a background pattern, which comprises two sets of lines intersecting each other; and
a transparent sheet, having one end attached to the original supporting sheet, for holding an original with the original supporting sheet, wherein through the transparent sheet a scan assembly for scanning the original obtains an image representing the original and the background pattern.

15. The carrier sheet according to claim 14, wherein the two sets of lines comprise:
a first set of lines comprising a plurality of first lines; and
a second set of lines comprising a plurality of second lines.

16. The carrier sheet according to claim 15, wherein the first lines are equally spaced, and the second lines are equally spaced.

17. The carrier sheet according to claim 15, wherein the first lines are unequally spaced, and the second lines are unequally spaced.

18. The carrier sheet according to claim 14, wherein the two sets of lines comprise straight lines.

19. The carrier sheet according to claim 14, wherein the two sets of lines comprise curved lines.

20. The carrier sheet according to claim 14, wherein the two sets of lines comprise multiple colors.
